(19) United States
(12) Patent Application Publication
(10) Pub. No.: US 2012/0202938 A1
(43) Pub. Date: Aug. 9, 2012

(54) FLUOROELASTOMER PARTS FOR OIL AND GAS EXPLORATION AND PRODUCTION

(75) Inventors: Tsuyoshi Kawai, Tochigi (JP); Makio Mori, Kanagawa (JP); Shuichi Okutsu, Kanagawa (JP); Kenji Terauchi, Tochigi (JP)

(73) Assignee: E. I. DU PONT DE NEMOURS AND COMPANY, Wilmington, DE (US)

(21) Appl. No.: 13/204,064

(22) Filed: Aug. 5, 2011

Related U.S. Application Data
(60) Provisional application No. 61/376,773, filed on Aug. 25, 2010.

(51) Int. Cl. C08L 27/16; C08K 3/04

(52) U.S. Cl. 524/495

(57) ABSTRACT

A cured fluoroelastomer part for use in oil and gas exploration and production comprises A) fluoroelastomer having at least 53 wt. % fluorine, and B) more than 20 parts by weight, per hundred parts by weight fluoroelastomer, of carbon black a nitrogen adsorption specific surface area of 70-150 m²/g and a dibutyl phthalate absorption of 90-180 ml/100 g.

### CROSS-REFERENCE TO RELATED APPLICATIONS

This application claims the benefit of U.S. Provisional Application No. 61/376,773 filed Aug. 25, 2010.

### FIELD OF THE INVENTION

This invention pertains to cured fluoroelastomer parts comprising fluoroelastomer and more than 20 parts by weight, per hundred parts by weight fluoroelastomer, of carbon black having a nitrogen adsorption specific surface area (N2SA) of 70-150 m²/g and a dibutyl phthalate (DBP) absorption of 90-180 ml/100 g.

### BACKGROUND OF THE INVENTION

Fluoroelastomers having excellent heat resistance, oil resistance, and chemical resistance have been used widely for sealing materials, containers and hoses.

Production of such fluoroelastomers by emulsion polymerization methods is well known in the art; see for example U.S. Pat. Nos. 4,214,060 and 3,876,654.

Fluoroelastomer compositions are typically filled with either a black (e.g. carbon black) or white (e.g. barium sulfate) filler in order to optimize tensile properties. Medium thermal (MT) carbon black such as N990 is a popular filler.

Fluoroelastomers are generally cured (i.e. crosslinked) by either a polyhydroxy compound (e.g. bisphenol AF) or by the combination of an organic peroxide and a multifunctional coagent (e.g. triallyl isocyanurate). Typically at least 2 parts by weight, per hundred parts by weight fluoroelastomer, of polyhydroxy compound or multifunctional coagent is employed in order to achieve good compression set resistance.

Fluoroelastomer parts for use in oil and gas exploration and production include mud pump motor linings and sealing elements on gate valves, electrical boots, perforating guns, packers, etc. Such parts are exposed to very high temperatures and high pressure during use and are typically required to be sufficiently hard so as to be resistant to extrusion and abrasion under high pressure. Such high hardness fluoroelastomer parts often have high tensile strength, but low elongation at break (Eb). Low Eb is a cause of cracks in the fluoroelastomer parts and also a cause of poor explosive decompression resistance. Therefore, for oil and gas exploration and production, it is important to achieve well-balanced fluoroelastomer part mechanical properties and hardness at high temperature and pressure.

### SUMMARY OF THE INVENTION

Surprisingly, it has been found that certain highly reinforcing carbon black fillers provide superior mechanical properties to fluoroelastomer parts employed at high temperature and pressure. One aspect of the present invention provides a cured fluoroelastomer part for use in oil and gas exploration and production comprising:

(A) fluoroelastomer having at least 53 weight percent fluorine, said fluoroelastomer comprising copolymerized units of vinylidene fluoride and at least one copolymerizable monomer;

(B) more than 20 parts by weight, per hundred parts by weight fluoroelastomer, of carbon black having a nitrogen adsorption specific surface area of 70-150 m²/g and a dibutyl phthalate absorption of 90-180 ml/100 g;

(C) less than 4 parts by weight, per hundred parts by weight fluoroelastomer, of a polyol curative; and

(D) 0.2 to 1 parts by weight, per hundred parts by weight fluoroelastomer, of a cure accelerator.

Another aspect of the present invention provides a cured fluoroelastomer part for use in oil and gas exploration and production comprising:

(A) fluoroelastomer having at least 53 weight percent fluorine, said fluoroelastomer comprising copolymerized units of vinylidene fluoride and at least one copolymerizable monomer;

(B) 10 to 30 parts by weight, per hundred parts by weight fluoroelastomer, of carbon black having a nitrogen adsorption specific surface area of 70-150 m²/g and a dibutyl phthalate absorption of 90-180 ml/100 g;

(C) 0.25 to 2 parts by weight, per hundred parts by weight fluoroelastomer, of organic peroxide; and

(D) less than 6 parts by weight, per hundred parts by weight fluoroelastomer, of a multifunctional coagent.

### DETAILED DESCRIPTION OF THE INVENTION

The present invention is directed to a cured (i.e. crosslinked) fluoroelastomer part for use in oil and gas exploration (e.g. drilling) and production. By “fluoroelastomer” is meant an amorphous elastomeric fluoropolymer. The fluoropolymer contains at least 53 percent by weight fluorine, preferably at least 64 wt. % fluorine. Fluoroelastomers that may be employed in the process of this invention contain between 25 to 70 weight percent, based on the weight of the fluoroelastomer, of copolymerized units of vinylidene fluoride (VF₂). The remaining units in the fluoroelastomers are comprised of one or more additional copolymerized monomers, different from said VF₂, selected from the group consisting of fluorine-containing olefins, fluorine-containing vinyl ethers, hydrocarbon olefins and mixtures thereof.

Fluorine-containing olefins copolymerizable with the VF₂ include, but are not limited to, hexafluoropropylene (HFP), tetrafluoroethylene (TFE), 1,2,3,3,3-pentafluoropropene (1-HPFP), chlorotrifluoroethylene (CTFE) and vinyl fluoride.

Fluorine-containing vinyl ethers copolymerizable with VF₂ include, but are not limited to perfluoro(alkyl vinyl) ethers. Perfluoro(alkyl vinyl) ethers (PAVE) suitable for use as monomers include those of the formula

CF₂═CFO(R_{f′}O)ₙ(R_{f″}O)ₘR_{f} (I)

where R_{f′} and R_{f″} are different linear or branched perfluoroalkylene groups of 2-6 carbon atoms, m and n are independently 0-10, and R_{f} is a perfluoroalkyl group of 1-6 carbon atoms.

A preferred class of perfluoro(alkyl vinyl) ethers includes compositions of the formula

CF₂═CFO(CF₂CFXO)ₙR_{f} (II)

where X is F or CF₃, n is 0-5, and R_{f} is a perfluoroalkyl group of 1-6 carbon atoms.

A most preferred class of perfluoro(alkyl vinyl) ethers includes those ethers wherein n is 0 or 1 and R_{f} contains 1-3 carbon atoms. Examples of such perfluorinated ethers include perfluoro(methyl vinyl) ether (PMVE) and perfluoro(propyl vinyl) ether (PPVE). Other useful monomers include compounds of the formula

CF₂═CFO[(CF₂)ₘCF₂CFZO]ₙR_{f} (III)

where R_{f} is a perfluoroalkyl group having 1-6 carbon atoms, m=0 or 1, n=0-5, and Z═F or CF₃. Preferred members of this class are those in which R_{f} is C₃F₇, m=0, and n=1.

Additional perfluoro(alkyl vinyl) ether monomers include compounds of the formula

CF₂═CFO[(CF₂CF{CF₃}O)ₙ(CF₂CF₂CF₂O)ₘ(CF₂)ₚ]CₓF₂ₓ₊₁ (IV)

where m and n independently=0-10, p=0-3, and x=1-5.

Preferred members of this class include compounds where n=0-1, m=0-1, and x=1.

Other examples of useful perfluoro(alkyl vinyl ethers) include

CF₂═CFOCF₂CF(CF₃)O(CF₂O)ₘCₙF₂ₙ₊₁ (V)

where n=1-5, m=1-3, and where, preferably, n=1.

If copolymerized units of PAVE are present in fluoroelastomers employed in this invention, the PAVE content generally ranges from 25 to 75 weight percent, based on the total weight of the fluoroelastomer. If perfluoro(methyl vinyl) ether is used, then the fluoroelastomer preferably contains between 30 and 55 wt. % copolymerized PMVE units.

The fluoroelastomers employed in the cured article of the present invention may also, optionally, comprise units of one or more cure site monomers. Examples of suitable cure site monomers include: i) bromine-containing olefins; ii) iodine-containing olefins; iii) bromine-containing vinyl ethers; iv) iodine-containing vinyl ethers; v) 1,1,3,3,3-pentafluoropropene (2-HPFP); and vi) non-conjugated dienes.

Brominated cure site monomers may contain other halogens, preferably fluorine. Examples of brominated olefin cure site monomers are CF₂═CFOCF₂CF₂CF₂OCF₂CF₂Br; bromotrifluoroethylene; 4-bromo-3,3,4,4-tetrafluorobutene-1 (BTFB); and others such as vinyl bromide, 1-bromo-2,2-difluoroethylene; perfluoroallyl bromide; 4-bromo-1,1,2-trifluorobutene-1; 4-bromo-1,1,3,3,4,4,-hexafluorobutene; 4-bromo-3-chloro-1,1,3,4,4-pentafluorobutene; 6-bromo-5,5,6,6-tetrafluorohexene; 4-bromoperfluorobutene-1 and 3,3-difluoroallyl bromide. Brominated vinyl ether cure site monomers useful in the invention include 2-bromo-perfluoroethyl perfluorovinyl ether and fluorinated compounds of the class CF₂Br—R_{f}-O—CF═CF₂(R_{f} is a perfluoroalkylene group), such as CF₂BrCF₂O—CF═CF₂, and fluorovinyl ethers of the class ROCF═CFBr or ROCBr═CF₂ (where R is a lower alkyl group or fluoroalkyl group) such as CH₃OCF═CFBr or CF₃CH₂OCF═CFBr.

Suitable iodinated cure site monomers include iodinated olefins of the formula: CHR═CH—Z—CH₂CHR—I, wherein R is —H or —CH₃; Z is a C₁-C₁₈ (per)fluoroalkylene radical, linear or branched, optionally containing one or more ether oxygen atoms, or a (per)fluoropolyoxyalkylene radical as disclosed in U.S. Pat. No. 5,674,959. Other examples of useful iodinated cure site monomers are unsaturated ethers of the formula: I(CH₂CF₂CF₂)ₙOCF═CF₂ and ICH₂CF₂O[CF(CF₃)CF₂O]ₙCF═CF₂, and the like, wherein n=1-3, such as disclosed in U.S. Pat. No. 5,717,036. In addition, suitable iodinated cure site monomers including iodoethylene, 4-iodo-3,3,4,4-tetrafluorobutene-1(ITFB); 3-chloro-4-iodo-3,4,4-trifluorobutene; 2-iodo -1,1,2,2-tetrafluoro-1-(vinyloxy)ethane; 2-iodo-1-(perfluorovinyloxy)-1,1,-2,2-tetrafluoroethylene; 1,1,2,3,3,3-hexafluoro-2-iodo-1-(perfluorovinyloxy)propane; 2-iodoethyl vinyl ether; 3,3,4,5,5,5-hexafluoro-4-iodopentene; and iodotrifluoroethylene are disclosed in U.S. Pat. No. 4,694,045. Allyl iodide and 2-iodo-perfluoroethyl perfluorovinyl ether are also useful cure site monomers.

Examples of non-conjugated diene cure site monomers include, but are not limited to 1,4-pentadiene; 1,5-hexadiene; 1,7-octadiene; 3,3,4,4-tetrafluoro-1,5-hexadiene; and others, such as those disclosed in Canadian Patent 2,067,891 and European Patent 0784064A1. A suitable triene is 8-methyl-4-ethylidene-1,7-octadiene.

Of the cure site monomers listed above, preferred compounds, for situations wherein the fluoroelastomer will be cured with peroxide, include 4-bromo-3,3,4,4-tetrafluorobutene-1 (BTFB); 4-iodo-3,3,4,4-tetrafluorobutene-1 (ITFB); allyl iodide; and bromotrifluoroethylene. When the fluoroelastomer will be cured with a polyol, 2-HPFP is the preferred cure site monomer. However, a cure site monomer is not required in copolymers of vinylidene fluoride and hexafluoropropylene in order to cure with a polyol.

Units of cure site monomer, when present in the fluoroelastomers employed in the cured article of this invention, are typically present at a level of 0.05-10 wt. % (based on the total weight of fluoroelastomer), preferably 0.05-5 wt. % and most preferably between 0.05 and 3 wt. %.

Additionally, iodine-containing endgroups, bromine-containing endgroups or mixtures thereof may optionally be present at one or both of the fluoroelastomer polymer chain ends as a result of the use of chain transfer or molecular weight regulating agents during preparation of the fluoroelastomers. The amount of chain transfer agent, when employed, is calculated to result in an iodine or bromine level in the fluoroelastomer in the range of 0.005-5 wt. %, preferably 0.05-3 wt. %.

Examples of chain transfer agents include iodine-containing compounds that result in incorporation of bound iodine at one or both ends of the polymer molecules. Methylene iodide; 1,4-diiodoperfluoro-n-butane; and 1,6-diiodo-3,3,4,4,tetrafluorohexane are representative of such agents. Other iodinated chain transfer agents include 1,3-diiodoperfluoropropane; 1,6-diiodoperfluorohexane; 1,3-diiodo-2-chloroperfluoropropane; 1,2-di(iododifluoromethyl)-perfluorocyclobutane; monoiodoperfluoroethane; monoiodoperfluorobutane; 2-iodo-1-hydroperfluoroethane, etc. Also included are the cyano-iodine chain transfer agents disclosed in European Patent 0868447A1. Particularly preferred are diiodinated chain transfer agents.

Examples of brominated chain transfer agents include 1-bromo-2-iodoperfluoroethane; 1-bromo-3-iodoperfluoropropane; 1-iodo-2-bromo-1,1-difluoroethane and others such as disclosed in U.S. Pat. No. 5,151,492.

Other chain transfer agents suitable for use in the fluoroelastomers employed in this invention include those disclosed in U.S. Pat. No. 3,707,529. Examples of such agents include isopropanol, diethylmalonate, ethyl acetate, carbon tetrachloride, acetone and dodecyl mercaptan.

Specific fluoroelastomers which may be employed in the cured article of this invention include, but are not limited to those having at least 53 wt. % fluorine and comprising copolymerized units of i) vinylidene fluoride and hexafluoropropylene; ii) vinylidene fluoride, hexafluoropropylene and tetrafluoroethylene; iii) vinylidene fluoride, hexafluoropropylene, tetrafluoroethylene and 4-bromo-3,3,4,4-tetrafluorobutene-1; iv) vinylidene fluoride, hexafluoropropylene, tetrafluoroethylene and 4-iodo-3,3,4,4-tetrafluorobutene-1; v) vinylidene fluoride, perfluoro(methyl vinyl) ether, tetrafluoroethylene and 4-bromo-3,3,4,4-tetrafluorobutene-1; vi) vinylidene fluoride, perfluoro(methyl vinyl) ether, tetrafluoroethylene and 4-iodo-3,3,4,4-tetrafluorobutene-1; and vii) vinylidene fluoride, perfluoro(methyl vinyl) ether, tetrafluoroethylene and 1,1,3,3,3-pentafluoropropene.

Fluoroelastomers that may be employed in the cured parts of this invention are typically made in an emulsion polymerization process and may be a continuous, semi-batch or batch process.

The carbon black filler employed in this invention is a highly reinforcing, high structure black having a nitrogen adsorption specific surface area (ASTM D-6556) of 25-150 (preferably 70-150) m²/g and a dibutylphthalate (“DBP”) absorption (ASTM D-2414) of 65-190 (preferably 90-180) ml/100 g. Examples of such types of carbon black include, but are not limited to HAF (ASTM N330), ISAF (ASTM N220) and SAF (ASTM N110). HAF is preferred. Mixtures of various carbon blacks may be employed.

The amount of carbon black employed in the cured articles of this invention is greater than 20 (preferably 25 to 50) parts by weight per hundred parts by weight fluoroelastomer.

Fluoroelastomer and the selected highly reinforcing carbon black are combined in an internal mixer (e.g. Banbury®, Kneader or Intermix®). Internal mixers lack sufficient shear deformation in their inherent design to incorporate fine filler pigment with low fluidity fluoroelastomer polymer. However, it has been discovered that the low shear deformation may be compensated for by premixing the fluoroelastomer polymer alone in an internal mixer until the polymer temperature reaches at least 90° C. (preferably at least 100° C.). The highly reinforcing carbon black can then be added to the hot fluoroelastomer polymer. The formation of firm filler gel may be achieved by application of high shear rate and high temperature. For the proper formation of firm filler gel, the maximum mixing temperature is between 150° C. and 180° C., preferably between 155° C. and 170° C. The mixer rotor is set between 20 and 80 (preferably 30-60) revolutions per minute (rpm) so that the average shear rate is 500-2500 (preferably 1000-2000) s⁻¹.

When a peroxide curing system is employed to crosslink the articles of this invention, the level of multifunctional coagent (e.g. triallyl isocyanurate) is less than 6, preferably less than 5, parts by weight, per hundred parts by weight fluoroelastomer. The level of peroxide is 0.25-2, preferably 0.7-1.5, parts by weight, per hundred parts by weight fluoroelastomer.

When a polyol compound (e.g. bisphenol AF) is employed to crosslink the articles of this invention, the curative level is less than 4, preferably less than 3, parts by weight per hundred parts by weight fluoroelastomer. The level of accelerator (e.g. a quaternary ammonium or phosphonium salt) is typically 0.2-1.0, preferably 0.4-0.8, parts by weight, per hundred parts by weight fluoroelastomer.

Curative is added to the fluoroelastomer and carbon black mixture at a temperature below 120° C. in order to prevent premature vulcanization. The compound is then shaped and cured in order to manufacture the cured parts of the invention.

Optionally, the cured fluoroelastomer parts of the invention may contain further ingredients commonly employed in the rubber industry such as process aids, colorants, acid acceptors, etc.

Cured (i.e. crosslinked) fluoroelastomer parts of this invention have a remarkable balance of tensile strength and elongation at break at both room temperature and at high temperatures, even with high hardness. At a hardness of at least 87 at 23° C., tensile strength at break (Tb) is at least 18 MPa at 23° C. and at least 10 MPa at 175° C. Elongation at break (Eb) is at least 150% at 23° C. and at least 90% at 175° C.

### EXAMPLES

TEST METHODS

| | |
|---|---|
| Tensile properties | JIS K 6251 |
| Hardness | JIS K 6253 |

The invention is further illustrated by, but is not limited to, the following examples.

### Example 1 and Comparative Example A

Samples for testing were made by combining carbon black, metal oxides and Viton® A700 fluoroelastomer (available from DuPont) in a 1.0 L Kneader internal mixer operating at a rotor speed of 20-80 revolutions per minute, an average shear rate between 500 and 2500 s−1 and a mixing temperature between 120° and 180° C. The resulting mixtures were banded on a rubber mill and curative was added. Formulations are shown in Table I. Compounds were sheeted, cut into slabs, press cured at 177° C. for 10 minutes and post cured in an air oven at 232° C. for 24 hours. Tensile properties are also shown in Table I.

TABLE I

| Ingredients, phr¹ | Comp. Ex. A | Example 1 |
|---|---|---|
| A700 | 100 | 100 |
| MT Black (N990) | 50 | 0 |
| HAF Black (N330) | 0 | 35 |
| Ca(OH)₂ | 3 | 3 |
| MgO | 6 | 6 |
| VC50² | 1.6 | 1.6 |
| VPA#2³ | 0.5 | 0.5 |
| Tensile properties | | |
| Hardness, point, @23° C. | 87 | 89 |
| Tb, MPa, @23° C. | 15 | 20 |
| Tb, MPa, @175° C. | 6 | 11 |
| Eb, %, @23° C. | 150 | 180 |
| Eb, %, @175° C. | 70 | 110 |

¹parts by weight per hundred parts by weight rubber (i.e. fluoroelastomer)
²a mixture of bisphenol AF and a quaternary phosphonium salt accelerator available from DuPont.
³Viton ® process aid #2 available from DuPont.

### Example 2 and Comparative Example B

Comparative Example B was made by combining Viton® A700 fluoroelastomer and other ingredients on a rubber mill. Example 2 was made by combining carbon black, metal oxides and Viton® A700 fluoroelastomer in a 1.0 L Kneader internal mixer operating at a rotor speed of 20-80 revolutions per minute, an average shear rate between 200 and 2500 s⁻¹ and a mixing temperature between 120° and 180° C. The resulting mixtures were banded on a rubber mill and curative added. Compounds were sheeted, cut into slabs and cured as in the above example. Formulations and tensile properties are shown in Table II.

TABLE II

| Ingredients, phr¹ | Comp. Ex. B | Example 2 |
|---|---|---|
| A700 | 100 | 100 |
| HAF Black (N330) | 40 | 40 |
| Ca(OH)₂ | 3 | 3 |
| MgO | 6 | 6 |
| VC50 | 1.6 | 1.6 |
| Tensile properties | | |
| Hardness, point, | 89 | 93 |
| @23° C. | | |
| Tb, MPa, @23° C. | 18 | 25 |
| Tb, MPa, @175° C. | 7 | 13 |
| Eb, %, @23° C. | 120 | 160 |
| Eb, %, @175° C. | 60 | 100 |

What is claimed is:

1. A cured fluoroelastomer part for use in oil and gas exploration and production comprising:
(A) fluoroelastomer having at least 53 weight percent fluorine, said fluoroelastomer comprising copolymerized units of vinylidene fluoride and at least one copolymerizable monomer;
(B) 10 to 30 parts by weight, per hundred parts by weight fluoroelastomer, of carbon black having a nitrogen adsorption surface area of 70-150 m²/g and a dibutyl phthalate absorption of 90-180 ml/100g;
(C) less than 4 parts by weight, per hundred parts by weight fluoroelastomer, of a polyol curative; and
(D) 0.2 to 1 parts by weight, per hundred parts by weight fluoroelastomer, of a cure accelerator.

2. The cured fluoroelastomer part for use in oil and gas exploration and production of claim 1 wherein said carbon black is selected from the group consisting of ASTM N330, ASTM N220 and ASTM N110.

3. The cured fluoroelastomer part for use in oil and gas exploration and production of claim 2 wherein said carbon black is ASTM N330.

4. The cured fluoroelastomer part for use in oil and gas exploration and production of claim 1 wherein said part has a hardness of at least 87 at 23° C., an elongation at break of at least 90% at 175° C. and a tensile strength at break of at least 10 MPa at 175° C.

5. A cured fluoroelastomer part for use in oil and gas exploration and production comprising:
(A) fluoroelastomer having at least 53 weight percent fluorine, said fluoroelastomer comprising copolymerized units of vinylidene fluoride and at least one copolymerizable monomer;
(B) 10 to 30 parts by weight, per hundred parts by weight fluoroelastomer, of carbon black having a nitrogen adsorption specific surface area of 70-150 m²/g and a dibutyl phthalate absorption of 90-180 ml/100g;
(C) 0.25 to 2 parts by weight, per hundred parts by weight fluoroelastomer, of organic peroxide; and
(D) less than 6 parts by weight, per hundred parts by weight fluoroelastomer, of a multifunctional coagent.

6. The cured fluoroelastomer part for use in oil and gas exploration and production of claim 5 wherein said carbon black is selected from the group consisting of ASTM N330, ASTM N220 and ASTM N110.

7. The cured fluoroelastomer part for use in oil and gas exploration and production of claim 6 wherein said carbon black is ASTM N330.

8. The cured fluoroelastomer part for use in oil and gas exploration and production of claim 5 wherein said part has a hardness of at least 87 at 23° C., an elongation at break of at least 90% at 175° C. and a tensile strength at break of at least 10 MPa at 175° C.
